(19) United States
(12) Patent Application Publication
(10) Pub. No.: US 2020/0210614 A1
(43) Pub. Date: Jul. 2, 2020

(54) SYSTEM AND METHOD FOR PROTECTING PERSONAL INFORMATION USING HIGH-SPEED SEARCHING, SANITIZATION AND SYMBOLIC LINK BASED ON FILE SYSTEM

(71) Applicant: Cottoncandy Co., Ltd., Daejeon (KR)

(72) Inventor: Seung Lee Nam, Suwon-si (KR)

(73) Assignee: Cottoncandy Co., Ltd., Daejeon (KR)

(21) Appl. No.: 16/278,190

(22) Filed: Feb. 18, 2019

(30) Foreign Application Priority Data
Dec. 26, 2018 (KR) 10-2018-0168936

(51) Int. Cl. G06F 21/62; G06F 16/14; G06F 16/16; G06F 16/17

(52) U.S. Cl. CPC G06F 21/6245; G06F 16/1734; G06F 16/162; G06F 16/148

(57) ABSTRACT

A system for protecting personal information using high-speed searching, sanitization, and a symbolic link based on a file system, includes a personal information file detection unit configured to detect a file including personal information in files stored in a closed network terminal and a symbolic link generation unit configured to copy the filed detected by the personal information file detection unit to a designated location of a file server, delete the detected file to the closed network terminal, and generate a symbolic link.

### TECHNICAL FIELD

The present invention relates to a system and a method for efficiently providing protection of personal information using sanitization and a symbolic link of a file stored in a device such as a PC.

### BACKGROUND ART

With the development of the Internet, many kinds of companies are operating business activities via the Internet, and attracting a large number of potential customers through membership. Customers need to input their personal information basically for the membership, and to set up personal identifiers such as IDs and passwords for subsequent access authentication.

These personal identifiers may vary from person to person, but may amount from a few to dozens in some cases, and as such, there is a problem in that as the number of companies with individual membership increased, it is difficult to manage personal identifiers registered in each company.

In order to solve these problems, a program for managing individual identifiers on the Internet has emerged. However, since the management program is installed in each client and the personal information registered in each company server is simply stored in a database form, there is a risk that the personal information is exposed due to internal or external hacking.

Further, in the case of managing the corresponding file for protection of personal information, it is difficult to determine whether the personal information is included in the registered file. Particularly, there are methods for determining whether a file stored in a device such as a PC includes the personal information, but there is a possibility of false positives and it is difficult for the automatic/forced processing of such files to operate effectively. For example, even if there is a solution for automatically deleting a file that is determined to include the personal information, it is virtually impossible to apply the solution to the business because of the possibility of false positives.

### PRIOR ART DOCUMENT

### Patent Document

(Patent Document 1) Korean Patent Publication No. 10-2015-0145896 (Publication Date: Dec. 31, 2015)
(Patent Document 2) Korean Patent Publication No. 10-2018-0113295 (Publication Date: Oct. 16, 2018)

### DISCLOSURE

### Technical Problem

Therefore, the present invention has been made to solve the above problems, and an object of the present invention is to provide a system and a method for efficiently providing protection of personal information that accurately searches whether a file stored in a device such as a PC at high speed, sanitizes a file including the personal information stored in the device, and generates a symbolic link by performing a copy in a specific local area.

Other objects of the present invention are not limited to the objects described above, and other objects, which are not mentioned above, will be apparent to those skilled in the art from the following description.

### Technical Solution

According to the present invention to achieve the objects, there is provided a system for protecting personal information using high-speed searching, sanitization, and a symbolic link based on a file system including: a personal information file detection unit configured to detect a file including personal information in files stored in a closed network terminal; and a symbolic link generation unit configured to copy the filed detected by the personal information file detection unit to a designated location of a file server, delete the detected file to the closed network terminal, and generate a symbolic link.

Preferably, the personal information file detection unit may include personal information by applying a high-speed searching technology based on a file system.

Preferably, the personal information file detection unit may include personal information using at least one of keyword-based searching, regular expression-based pattern matching, and artificial intelligence.

Preferably, the symbolic link generation unit may sanitize the copied file of the closed network terminal when the integrity is confirmed by using a size, a hash value, or the like of the detected file including the personal information.

According to the present invention to achieve the objects, there is provided a method for protecting personal information using high-speed searching, sanitization, and a symbolic link based on a file system including: (A) detecting, by a personal information file detecting unit, a file including personal information in files stored in a closed network terminal; (B) copying, by a symbolic link generation unit, the file detected by the personal information file detection unit to a designated location of a file server; (C) confirming, by the symbolic link generation unit, integrity using a size, a hash value, or the like of the detected file including the personal information; (D) sanitizing the copied file of the closed network terminal when the integrity is confirmed; and (E) generating, by the symbolic link generation unit, a symbolic link linked with the copied file in the file server in the closed network terminal.

Preferably, in step (A), a file including personal information may be detected by applying a high-speed searching technology based on a file system, and the high-speed searching technology may apply at least one of searching only a file having a specific extension in the files stored in the closed network terminal to detect the file included in the personal information, sensing a changed extension when an extension is changed by only a file whose extension is changed by history detection to search only a file having the changed extension and detecting a file including the personal information, and detecting a file including personal information by using file header information.

Preferably, step (A) may include detecting a file including personal information using at least one of keyword-based searching, regular expression-based pattern matching, and artificial intelligence.

Preferably, in step (B), a copy may be performed according to a predetermined rule in a specific local area (drive or folder) or a network storage (file server, cloud, etc.), and the predetermined rule may encode and store the file including the personal information, or decode the file including the personal information through an encoding processor.

### Advantageous Effects

As described above, the system and the method for protecting the personal information using high-speed searching, sanitization, and a symbolic link based on the file system according to the present invention have the following effects.

First, since the personal information is efficiently managed and serviced by each group and there is no file having personal information in files stored in a device such as a PC, it is possible to efficiently protect the personal information.

Second, by generating a symbolic link by performing a copy in a specific local area, there is an advantage of removing the risk of exposing personal information by internal and external hacking. Moreover, even in a client environment in which personal information is not stored, it is possible to rapidly use an encoding storage device by a symbolic link.

Third, it is possible to be used as a means of sharing personal information related to business for general companies and to be used for opinion gatherings and contacting of labor unions, social gatherings for reunions, meeting sites of religious organizations, homepages of government offices, and various associations and informal social gatherings.

### DESCRIPTION OF DRAWINGS

FIG. 1 is a block diagram illustrating a configuration of a system for protecting personal information using high-speed searching, sanitization, and a symbolic link based on a film system according to an embodiment of the present invention.

FIG. 2 is a flowchart for describing a method for protecting personal information using high-speed searching, sanitization, and a symbolic link based on a film system according to an embodiment of the present invention.

FIGS. 3A to 3E are diagrams illustrating Examples for describing the method for protecting personal information of FIG. 2.

### MODES OF THE INVENTION

Other objects, features and advantages of the present invention will be apparent from the detailed description of embodiments with reference to the accompanying drawings.

Preferred embodiments of a system and a method for protecting personal information using high-speed searching, sanitization, and a symbolic link based on a film system according to the present invention will be described below with reference to the accompanying drawings. However, the present invention is not limited to embodiments disclosed below but embodied in many different forms, and the present embodiments are merely to be provided to complete the disclosure of the present invention and fully inform the scope of the invention to those skilled in the art. Therefore, the embodiments described in the present specification and the configurations illustrated in the drawings are merely the most preferred embodiment of the present invention and are not intended to represent all of the technical ideas of the present invention, and thus, it should be understood that various equivalents and modifications capable of replacing the embodiments at the time of this application.

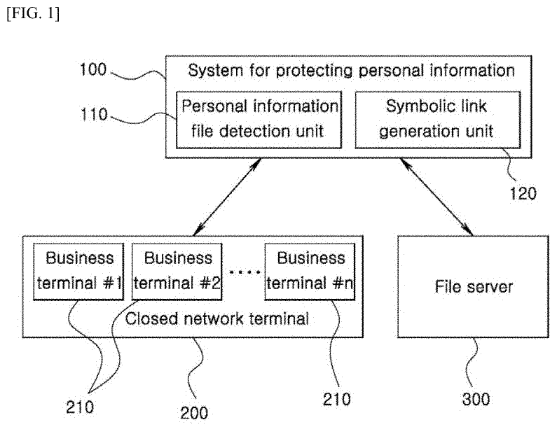

FIG. 1 is a block diagram illustrating a configuration of a system for protecting personal information using high-speed searching, sanitization, and a symbolic link based on a film system according to an embodiment of the present invention.

As illustrated in FIG. 1, a system 100 for protecting personal information of the present invention includes a personal information file detection unit 110 and a symbolic link generation unit 120. In addition, the system 100 includes a closed network terminal 200 and a file server 300 which communicate with a closed network with the system 100 for protecting personal information.

The closed network terminal 200 is a user terminal connected to a LAN through a restricted network of the closed network, and the personal information file is deleted and a symbolic link is displayed.

At this time, the closed network terminal 200 is a terminal possessed by a user who accesses the system 100 for protecting personal information and the file server 300 through the closed network to use a personal information protection service. The closed network terminal 200 includes a plurality of business terminals 210 and may be implemented as a PC, a smart phone, a PDA, a tablet PC, or the like.

The file server 300 copies the personal information file included in the closed network terminal 200 in a specific local area and provides a corresponding personal information file when the symbolic link displayed on the closed network terminal 200 is selected.

At this time, the file server 300 includes a program module which has the same configuration as a typical web server with hardware, and is implemented in various types of languages such as C, C++, Java, Visual Basic, and Visual C with software to perform various functions. The file server 300 may be implemented by using a web server program that is variously provided according to operating systems such as DOS, Windows, Linux, Unix, and Macintosh on general server hardware, and as typical examples, a website and an internet information server (IIS) used in a Windows environment, and CERN, NCSA, and APACHE used in a UNIX environment may be used.

The personal information file detection unit 110 of the system 100 for protecting personal information detects a file including the personal information in files stored in the closed network terminal 200.

At this time, the personal information file detection unit 110 may detect a file including the personal information by applying a high-speed searching technology based on a file system. The high-speed searching technology searches only a file having a specific extension (Excel, Word, Hangul, etc.) in the files stored in the closed network terminal 200 to detect the file included in the personal information. Alternatively, the personal information file detection unit 110 senses a changed extension when an extension is changed by only a file whose extension is changed by history detection to search only a file having the changed extension and detects a file including the personal information. Alternatively, the personal information file detection unit 110 detects a file including personal information by using file header information. At least one of these high-speed searching technologies may be applied.

The present invention is not limited thereto, and the personal information file detection unit 110 may detect a file including personal information using keyword-based searching, regular expression-based pattern matching, and artificial intelligence.

In addition, the symbolic link generation unit 120 of the system 100 for protecting personal information copies the file detected by the personal information file detection unit 110 to a designated location of the file server 300, deletes the detected file to the closed network terminal 200, and generates a symbolic link.

That is, the symbolic link generation unit 120 performs a copy according to a predetermined rule in a specific local area (drive or folder) or a network storage (file server, cloud, etc.). At this time, the predetermined rule may encode and store the file including the personal information, or decode the file including the personal information through an encoding processor.

At this time, the symbolic link generation unit 120 sanitizes the copied file of the closed network terminal 200 when the integrity is confirmed by using a size, a hash value, or the like of the detected file including the personal information.

An operation of the system for protecting the personal information using high-speed searching, sanitization, and a symbolic link based on the file system according to the present invention will be described below in detail with reference to the accompanying drawings. The same reference numerals as those in FIG. 1 designate the same members performing the same functions.

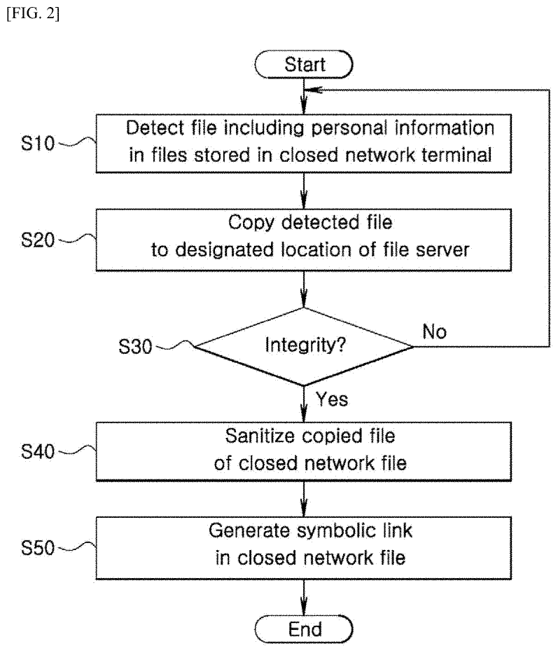

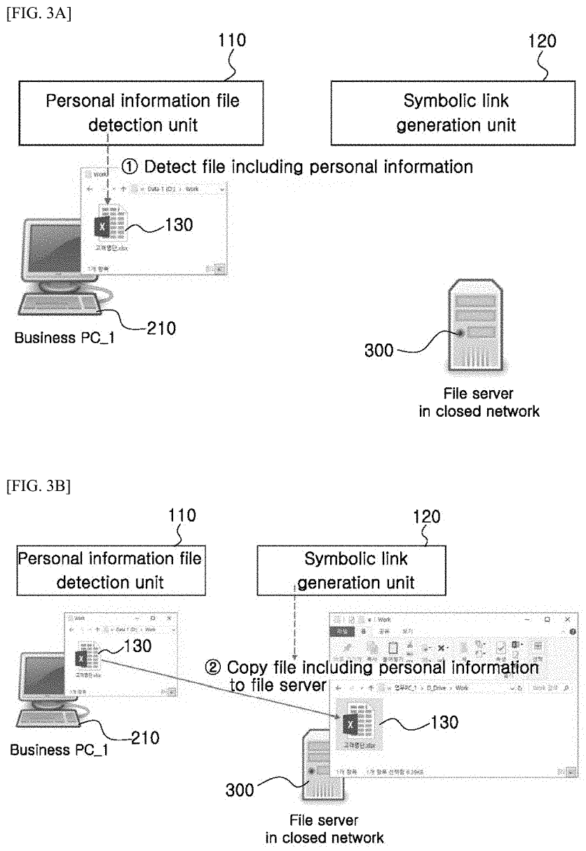

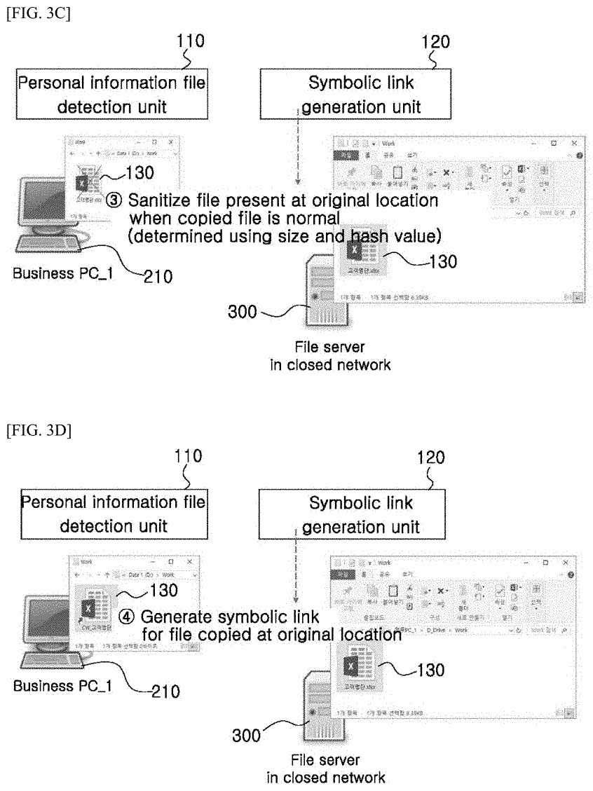

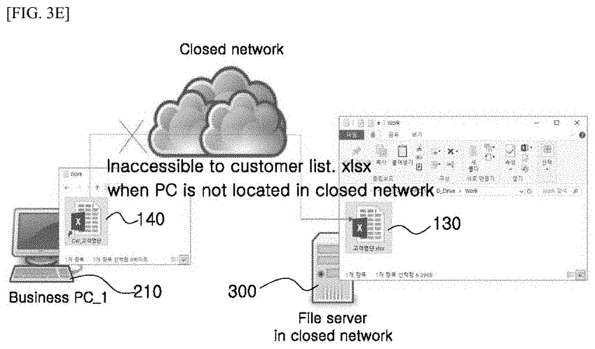

FIG. 2 is a flowchart for describing a method for protecting personal information using high-speed searching, sanitization, and a symbolic link based on a film system according to an embodiment of the present invention. FIGS. 3A to 3E are diagrams illustrating Examples for describing the method for protecting personal information of FIG. 2.

Referring to FIG. 2, first, as illustrated in FIG. 3A, the personal information file detecting unit 110 detects a file 130 including personal information in the files stored in the closed network terminal 200 (S10). At this time, the personal information file detection unit 110 may detect a file including the personal information by applying a high-speed searching technology based on a file system. The high-speed searching technology searches only a file having a specific extension (Excel, Word, Hangul, etc.) in the files stored in the closed network terminal 200 to detect the file included in the personal information. Alternatively, the personal information file detection unit 110 senses a changed extension when an extension is changed by only a file whose extension is changed by history detection to search only a file having the changed extension and detects a file including the personal information. Alternatively, the personal information file detection unit 110 detects a file including personal information by using file header information. At least one of these high-speed searching technologies may be applied.

The present invention is not limited thereto, and the personal information file detection unit 110 may detect a file including personal information using keyword-based searching, regular expression-based pattern matching, and artificial intelligence.

Next, as illustrated in FIG. 3B, the symbolic link generation unit 120 copies the file 130 detected by the personal information file detection unit 110 to a designated location of the file server 300 (S20). That is, the symbolic link generation unit 120 performs a copy according to a predetermined rule in a specific local area (drive or folder) or a network storage (file server, cloud, etc.). At this time, the predetermined rule may encode and store the file including the personal information, or decode the file including the personal information through an encoding processor.

Next, as illustrated in FIG. 3C, the symbolic link generation unit 120 confirms integrity using a size, a hash value, or the like of the detected file including the personal information (S30) and sanitizes the copied file 130 of the closed network terminal 200 when the integrity is confirmed (S40).

In addition, as illustrated in FIG. 3D, the symbolic link generation unit 120 generates a symbolic link 140 linked with the file copied to the file server 300 in the closed network terminal 200 (S50).

Through such a method, as illustrated in FIG. 3E, a personal device 210 such as a smart phone is applied to copy the detected file including the personal information to a private cloud storage 300, and thus there is no file including the personal information in the corresponding device 210 when the personal device 210 is lost, thereby efficiently protecting the personal information.

In addition, as illustrated in FIG. 3E, the business or personal device 210 is applied to copy the detected file including the personal information to a secure folder/drive 300 in a local, thereby reinforcing a personal information protection function of the corresponding device.

The technical spirit of the present invention described above is described in detail in the preferred embodiments, but it is to be noted that the above embodiments are for the description, not for limitation. It will be understood to those skilled in the art that various embodiments may be made without departing from the technical spirit of the present invention. Therefore, the true technical scope of the present invention should be defined by the technical spirit of the appended claims.

[Explanation of Reference Numerals and Symbols]

| | |
|---|---|
| 100: System for protecting | 110: Personal information |
| personal information | file detection unit |
| 120: Symbolic link generation unit | 200: Closed network terminal |
| 300: File server | |

1. A system for protecting personal information comprising:
a personal information file detection unit configured to detect a file including personal information in files stored in a closed network terminal; and
a symbolic link generation unit configured to copy the filed detected by the personal information file detection unit to a designated location of a file server, delete the detected file to the closed network terminal, and generate a symbolic link.

2. The system for protecting personal information of claim 1, wherein the personal information file detection unit detects a file including personal information by applying a high-speed searching technology based on a file system.

3. The system for protecting personal information of claim 1, wherein the personal information file detection unit detects a file including personal information using at least one of keyword-based searching, regular expression-based pattern matching, and artificial intelligence.

4. The system for protecting personal information of claim 1, wherein the symbolic link generation unit sanitizes the copied file of the closed network terminal when the integrity is confirmed by using a size, a hash value, or the like of the detected file including the personal information.

5. A method for protecting personal information comprising steps of:
(A) detecting, by a personal information file detecting unit, a file including personal information in files stored in a closed network terminal;
(B) copying, by a symbolic link generation unit, the file detected by the personal information file detection unit to a designated location of a file server;
(C) confirming, by the symbolic link generation unit, integrity using a size, a hash value, or the like of the detected file including the personal information;
(D) sanitizing the copied file of the closed network terminal when the integrity is confirmed; and
(E) generating, by the symbolic link generation unit, a symbolic link linked with the copied file in the file server in the closed network terminal.

6. The method for protecting personal information of claim 5, wherein in step (A), a file including personal information is detected by applying a high-speed searching technology based on a file system, and
the high-speed searching technology applies at least one of searching only a file having a specific extension in the files stored in the closed network terminal to detect the file included in the personal information, sensing a changed extension when an extension is changed by only a file whose extension is changed by history detection to search only a file having the changed extension and detecting a file including the personal information, and detecting a file including personal information by using file header information.

7. The method for protecting personal information of claim 5, wherein step (A) includes detecting a file including personal information using at least one of keyword-based searching, regular expression-based pattern matching, and artificial intelligence.

8. The method for protecting personal information of claim 5, wherein in step (B), a copy is performed according to a predetermined rule in a specific local area (drive or folder) or a network storage (file server, cloud, etc.), and the predetermined rule encodes and stores the file including the personal information, or decodes the file including the personal information through an encoding processor.
